(19) United States
(12) Patent Application Publication
(10) Pub. No.: US 2026/0079626 A1
(43) Pub. Date: Mar. 19, 2026

(54) MEMORY FREE LIST LATENCY BOUNDING TECHNIQUES

(71) Applicant: Marvell Asia Pte Ltd, Singapore (SG)

(72) Inventor: Wilson Parkhurst Snyder, II, Holliston, MA (US)

(73) Assignee: Marvell Asia Pte Ltd, Singapore (SG)

(21) Appl. No.: 19/330,235

(22) Filed: Sep. 16, 2025

Related U.S. Application Data
(60) Provisional application No. 63/695,790, filed on Sep. 17, 2024.

(51) Int. Cl. G06F 3/06

(52) U.S. Cl. CPC G06F 3/0613; G06F 3/0659; G06F 3/0683

(57) ABSTRACT

Memory free list latency bounding techniques may optimize the performance of parallel storage devices. In one example, a memory controller includes one or more registers that include pointers to free lists that include addresses of free locations in the memory devices. In various example, each free list corresponds to a memory device, memory module, or pseudo channel. The memory controller receives data to store in memory. The memory controller splits the data into data chunks, where a data chunk has a size that is greater than a memory access size. The memory controller then determines which free lists include addresses to free locations and selects one or more memory devices to store the data chunks based on the free lists. In one example, at least one of the memory devices is selected to store data chunks based on how recently the memory device was selected.

### PRIORITY APPLICATION

This patent application claims priority to and/or receives benefit from U.S. Provisional Application No. 63/695,790, titled, “Free List Latency Bounding,” filed on September 17, 2024. The U.S. Provisional Application is hereby incorporated by reference in its entirety.

### BACKGROUND

Dynamic Random-Access Memory (DRAM) is a type of volatile memory used in computing systems to store data. Unlike non-volatile memory, DRAM relies on continuous power to maintain the integrity of the stored data. DRAM is designed for high density and cost efficiency, making it a popular choice for main memory in computers and other electronic devices.

Latency in DRAM accesses refers to the delay between the initiation of a memory request and the completion of the data transfer. Several factors contribute to DRAM latency, including the time required to precharge bitlines, activate the appropriate row, and access the specific column within the row. DRAM latency may also be affected by refresh operations. Additionally, the memory controller's queuing and scheduling policies can introduce further delays. Reducing DRAM latency can result in improvements to the overall performance of a system.

### BRIEF DESCRIPTION OF THE DRAWINGS

Embodiments will be readily understood by the following detailed description in ‎conjunction with the accompanying drawings. To facilitate this description, like reference ‎numerals designate like structural elements. Embodiments are illustrated by way of ‎example, and not by way of limitation, in the figures of the accompanying drawings.

FIG. 1 illustrates an exemplary computing system in which memory free list latency bounding techniques may be implemented, according to some embodiments of the disclosure.

FIG. 2 illustrates an example of system memory in a computing system in which memory free list latency bounding techniques may be implemented, according to some embodiments of the disclosure.

FIG. 3 illustrates an example of a register to enable the implementation of memory free list latency bounding techniques, according to some embodiments of the disclosure.

FIG. 4 illustrates an example data structure to store a free list to enable the implementation of memory free list latency bounding techniques, according to some embodiments of the disclosure.

FIG. 5 illustrates an example diagram of a free list in memory, according to some embodiments of the disclosure.

FIG. 6 depicts a flow chart illustrating an example of a method implementing memory free list latency bounding techniques, according to some embodiments of the disclosure.

FIG. 7 illustrates a diagram showing an example of data handled in accordance with the method of FIG. 6, according to some embodiments of the disclosure.

FIG. 8 illustrates an exemplary memory module, which may be included in a system implementing memory free list latency bounding techniques, according to some embodiments of the disclosure.

FIG. 9 illustrates an exemplary memory controller in which memory free list latency bounding techniques may be implemented, according to some embodiments of the disclosure.

FIG. 10 illustrates an exemplary computing system, in which memory free list latency bounding technique may be implemented, according to some embodiments of the disclosure.

### DETAILED DESCRIPTION

### Overview

In a computing system, a requestor (e.g., a host) retrieves data from multiple storage media. The time required for the requestor to retrieve the data (referred to as read latency), is partially determined by the time it takes to read the data from storage. A reduction in read latency may result in an improvement in system performance.

In one example, a technique referred to as striding may be used to reduce latency. In one example, striding involves distributing memory requests across multiple memory controllers, relying on predictable access patterns. In one such example, when a memory request is made, instead of sending all the data to a single memory controller, the data is divided into units having the size of a memory access (e.g., a 64 byte (64B)-cache line or another memory access size). In one example, the divided data may then be distributed to different memory controllers based on a modulus operation. For example, consider a system with a memory controller coupled with four memory modules (e.g., DRAM dual inline memory modules (DIMMs)), where the memory controller has a DRAM controller corresponding to each of the four memory modules. In one such example where the memory controller is writing 256B, instead of sending the 256B of data to a single controller, the memory controller may send a 64B cache line to each of the memory controllers to cause a 64B cache line to be sent to each of the four memory modules. In some cases, striding can result in latency reduction due to parallelization. However, one disadvantage of striding is that for each 256B chunk of data, each of the DRAM controllers is activated, increasing power consumption (e.g., due to commands such as precharge sent to each memory module).

In one example, to take advantage of the efficiencies from sequential memory accesses while also improving read latency, a technique to distribute memory accesses across multiple memory devices may be performed at a higher level and with a higher granularity. For example, a memory controller can split data to be stored in memory into larger chunks (e.g., chunks having a size greater than the memory access size, such as 256B) and distribute the larger chunks across multiple memory devices. A memory controller may determine which memory devices have free space for eventual chunk storage, by maintaining a free list for the memory devices (the free list containing chunk pointers that point to the location a chunk may be stored in the future). In one such example, a single free list may be maintained for a plurality of memory devices. When the memory controller receives a store request, the memory controller may obtain addresses of free locations from the free list (e.g., in the case of a last-in-first-out (LIFO) stack, the memory controller may pop off addresses from the free list stack). Consider an example in which the memory controller is to store four 256B-chunks. In one such example, the memory controller may obtain four addresses from the free list. If the addresses of free locations are added to the free list in a sequential/successive manner (e.g., a first address in the list maps to a first memory device, a second address in the list maps to a second memory device, and so forth), four addresses obtained from the free list may target four different memory devices. However, in some examples, after enough system activity that results in the removal and addition of many addresses to/from the free list, the free list may include an effectively random order of addresses, which may not result in the distribution of accesses across memory devices other than by random chance. For example, the free list may include four addresses targeting the same memory device in a row. With a free list that has addresses of free locations across multiple memory devices in a random order, the maximum observed latency (referred to as tail latency) may be very high (e.g., in situations where the free list has a series of many addresses to the same memory device).

In accordance with examples described herein, memory free list latency bounding techniques may optimize the use of the storage devices for parallel access with a higher granularity than conventional striding. In one example, a memory controller includes one or more registers that include pointers to free lists that include addresses of free locations in the memory devices. In one such example, each free list corresponds to a memory device (which as used herein, may refer to a memory module or pseudo channel or sub-channel of a memory module) and/or a DRAM controller of the memory controller. The memory controller receives data to store in memory. The memory controller splits the data into data chunks, where a data chunk has a size that is greater than a memory access size. The memory controller then determines which free lists include addresses to free locations and selects one or more memory devices to store the data chunks based on the free lists. In one example, at least one of the memory devices is selected to store data chunks based on how recently the memory device was selected relative to other available memory devices. In one such example, the chunks are distributed across multiple memory devices, which may decrease the average latency and bound the tail latency, which may be of special interest in high-performance hyperscale processing applications.

### Exemplary computing systems

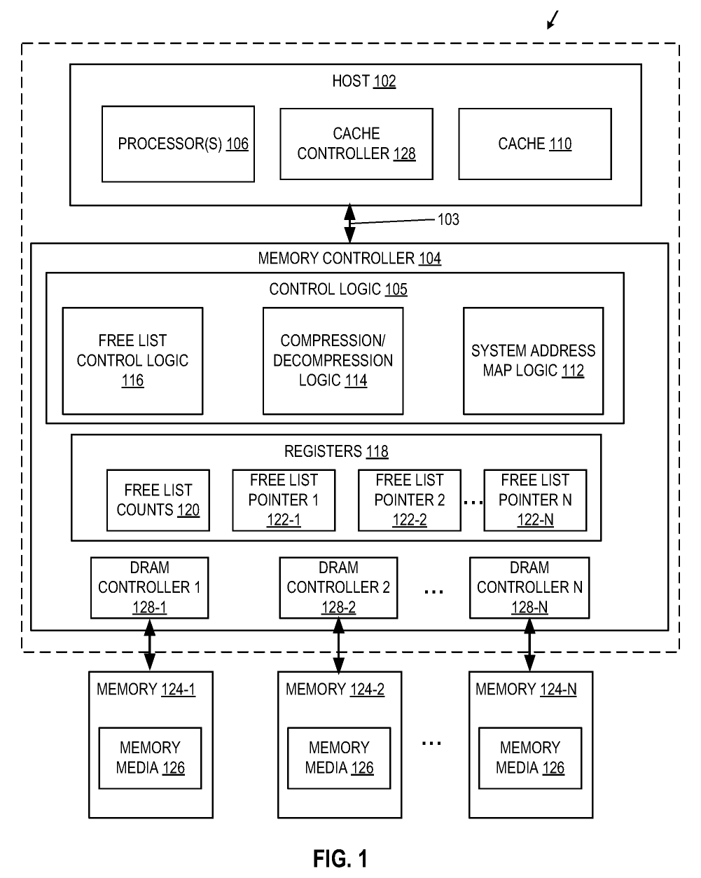

FIG. 1 illustrates an exemplary computing system 100 in which memory free list latency bounding techniques may be implemented. The system 100 includes a host device 102, memory devices 124-1-124-N (of which memory devices 124-1, 124-2, and 124-N are depicted), and a memory controller 104 coupled with and between the host device 102 and the memory devices 124-1-124-N.

The host device 102, which may also be referred to as a requester, is the source of memory access requests to the memory devices 124-1-124-N. The host device 102 may be a device or system that initiates and/or manages data processing and storage operations. The host device 102 may include one or more processors 106, including one or more central processing units (CPUs), one or more graphics processing units (GPUs), one or more digital signal processors, and/or other processors. The host device 102 may include a cache 110 comprising high-speed memory storage for temporarily storing frequently accessed data, instructions, or metadata to reduce access latency to slower storage devices or main memory. The cache 110 may implement various caching algorithms and policies to optimize data retrieval performance and may include multiple cache levels with different sizes and access speeds. The cache 110 may include different cache levels such as level 1 (L1) cache, level 2 (L2) cache, and last level cache (LLC), where the cache may be implemented using static random-access memory (SRAM) or other high-speed memory technologies. In one example, the cache 110 is a page cache that stores pages, where a page includes multiple cache lines.

The host device 102 may include a cache controller 128 coupled with the cache 110, where the cache controller 128 manages cache operations including cache line allocation, replacement policies, coherency protocols, and data movement between the cache 110 and other components of the system 100. The cache controller 128 may implement algorithms for determining cache hits and misses, managing cache eviction policies such as least recently used (LRU) or first-in-first-out (FIFO), and coordinating data transfers. The cache controller 128 may include logic circuitry and control registers for monitoring cache utilization and implementing cache management functions.

The system 100 includes a memory controller 104, which may be external from the processor(s) 106 of the host device 102 or integrated on the same die as the processor(s) 106 (as indicated with the dashed-line box around the memory controller 104 and the host device 102). In some examples, the memory controller 104 is coupled with the host device 102 via a Compute Express Link (CXL) interface, Peripheral Component Interconnect Express (PCIe) interface, or other suitable communication interface for managing memory operations and data transfers between the host device 102 and memory controller 104.

In some examples, the memory controller 104 may include or be implemented as a memory expander (e.g., a memory expansion controller) that increases the total memory capacity available to the host device 102. For example, a memory controller 104 that is configured as a memory expander may support multiple memory channels and enable connection of additional memory modules beyond the capacity limitations of standard motherboard memory slots. The memory controller 104 may implement memory expansion functionality through application-specific integrated circuits (ASICs) or other control logic.

The memory controller 104 includes control logic 105 to control memory access operations including read operations, write operations, refresh operations, and power management functions for the memory devices 124-1-124-N. In some examples, the control logic 105 of the memory controller 104 may implement memory scheduling algorithms, error correction protocols, and address translation functions to optimize memory performance and maintain data integrity across the memory devices 124-1-124-N. The memory controller 104 may include DRAM controllers 128-1-128-N (of which DRAM controllers 128-1, 128-2, and 128-N are shown) that manage communication and control operations with corresponding memory devices 124-1-124-N, where each of the DRAM controllers 128-1-128-N may handle memory access commands, timing protocols, refresh operations, and electrical signaling for its associated DRAM device or channel. For example, the DRAM controller 128-1 may control access to the memory device 124-1, the DRAM controller 128-2 may control access to the memory device 124-2, and so forth. The DRAM controllers 128-1-128-N may implement DRAM-specific protocols including row activation, column access, precharge operations, and may coordinate power management functions and error correction procedures for their respective memory devices.

In the example illustrated in FIG. 1, the control logic 105 includes system address map logic 112 to translate logical addresses from the host device 102 into physical addresses for accessing specific locations within the memory devices 124-1-124-N. The system address map logic 112 may implement address decoding functions and routing decisions to determine which memory device and specific memory location corresponds to a given system address request. The control logic 105 of the memory controller 104 may also include compression/decompression logic 114 that compresses data before storing it in the memory devices 124-1-124-N and decompresses data after retrieving it from memory. The compression/decompression logic 114 may implement various compression algorithms.

The memory controller 104 includes registers 118 for storing configuration parameters, status information, control settings, and operational data related to memory management functions. The registers 118 include one or more registers related to free lists, including free list pointers 122-1-122-N (of which free list pointer 122-1, 122-2, and 122-N are shown in FIG. 1). The free list pointers 122-1-122-N are pointers (e.g., addresses) to one or more locations in memory (e.g., in the memory devices 124-1-124-N) where the free lists are stored. The addresses in the free lists are locations for storing data chunks, and may therefore be referred to as “chunk pointers.” The registers 118 may also include one or more registers that indicate free list counts 120. In one example, the free list counts 120 include the counts of free locations in the free lists, or other information that enable the free list control logic 116 to determine how many free locations are in a corresponding memory device. Although the free list counts 120 and the free list pointers 122-1-122-N are shown as separate boxes, such information may be stored in one register or multiple registers and in one or multiple fields.

The control logic 105 also includes free list control logic 116. The free list control logic 116 manages the free lists corresponding to the memory devices 124-1-124-N. A free list includes addresses of free locations (e.g., locations that are available to be written to) in a corresponding memory device. In some examples, the memory controller may maintain one free list per DRAM controller (e.g., for each of the DRAM controllers 128-1-128-N). Viewed from another perspective, the memory controller could be considered as maintaining one free list per memory device 124-1-124-N (e.g., where the memory controller 104 includes one DRAM controller 128-1-128-N per memory device 124-1-124-N). Although examples described herein refer to each memory device having a corresponding free list, in some examples, multiple memory devices (e.g., two memory devices) may correspond to one free list. Additionally, the term “memory device” as used in reference to free lists may refer to a memory device, a memory module (such as a DIMM or other memory module) that includes multiple memory devices, a pseudo channel of a memory module, or any other addressable memory resource.

Management of the free lists by the free list control logic 116 may involve: initializing free lists and registers related to the free lists (e.g., the free list counts 120 and the free list pointers 122-1-122-N), enabling free lists, adding addresses to the free lists, and removing addresses from the free lists. In one example, a given free list may be stored as a list (e.g., linked list) of addresses and managed as stacks (e.g., LIFO), queues (e.g., FIFO), or using other data structures. In one example, management of the free lists may involve freeing pointers in the free lists (e.g., in response to a free page request (e.g., writing a page with all zeros) from the host or a trim command). In one such example, to free pointers in the free lists, the free list control logic 116 may identify the addresses (e.g., chunk pointers) for the page being freed. Each chunk pointer may then be subsequently freed to the same free list from which it was originally allocated. In one such example, this can be achieved by storing the free list numbers (e.g., in a table in memory with an entry for each page). In another example, the chunk pointers may be decoded to determine the corresponding memory device (e.g., using upper address bits), and once the corresponding memory device is identified, the free list control logic 116 may determine the corresponding free list for that memory device.

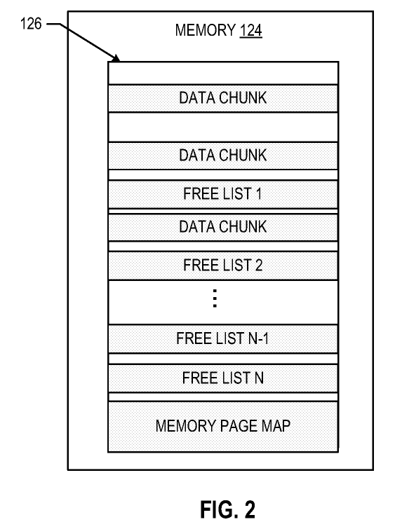

The memory devices 124-1-124-N represent memory resources for use by the host device 102 for storing instructions and data that the host device 102 processes and accesses to perform operations. Instructions stored in memory may include instructions of a driver, an operating system, an application, a virtual machine (VM), a tenant, or any other application. Data may include data stored by the host. The memory devices 124-1-124-N may also store other information, such as a memory page map (indirection table) to enable address translation and the free lists with addresses of free locations in the memory devices 124-1-124-N, such as shown in FIG. 2. As can be seen in FIG. 2, memory 124 (which may represent a memory range from one or multiple memory devices) may include data chunks written in response to data store requests from a host, free lists (e.g., N free lists, of which free list 1, free list 2, free list N-1, and free list N are shown), and a memory page map.

Referring again to FIG. 1, the memory devices 124-1-124-N may include various types of memory, such as DRAM, non-volatile memory, SRAM, and/or Flash memory. In some examples, the memory devices 124-1-124-N and memory controller 104 comply with a memory standard such as double data rate (DDR) version 5 (DDR5) (JEDEC JESD79-5), DDR version 4 (DDR4) (JEDEC JESD79-4), DDR version 3 (DDR3) (JEDEC JESD79-3), low power DDR version 5 (LPDDR5) (JEDEC JESD209-5), LPDDR version 4 (LPDDR4) (JEDEC JESD209-4), high bandwidth memory (HBM) version 4 (HBM4) (JEDEC JESD270-4), HBM version 3 (HBM3) (JEDEC JESD238), HBM version 2 (HBM2) (JEDEC JESD235), graphics DDR version 6 (GDDR6) (JEDEC JESD250), other or future versions of these standards, and/or other memory standards.

Each of the memory devices 124-1-124-N includes memory media 126, which refers to the physical storage medium that is capable of storing data. In one example, the memory media 126 includes arrays of memory cells (e.g., DRAM memory cells or other memory cells). In some examples, the memory media 126 may be arranged in banks, where a DRAM bank is an independent portion of memory within a given DRAM device that can be operated separately from other banks. In one example, the memory devices 124-1-124-N may represent memory modules, such as a DIMMs, where each DIMM includes multiple DRAM devices (e.g., DRAM dies) that are mounted on a printed circuit board. In one such example, the DRAM devices may interface with the host device 102 and memory controller 103 via edge connector pins or contacts (not shown in FIG. 1). In some examples, a memory module may include multiple pseudo channels, where a pseudo channel includes memory devices of the memory module (or where a group of memory devices corresponds to one of the pseudo channels).

Thus, the system 100 includes a host device 102, a plurality of memory devices 124-1-124-N, and a memory controller 104 that is between and coupled with the host device 102 and the memory devices 124-1-124-N. In response to a request to store data from the host device 102, the memory controller 104 may split the data into data chunks and select one or more of the memory devices 124-1-124-N to store the data chunks. In one such example, selection of memory devices for storage of the data chunks may depend on the corresponding free lists and also based on how recently the memory devices were selected for data chunk storage, as explained in more detail below.

Exemplary register to enable memory free list latency bounding techniques

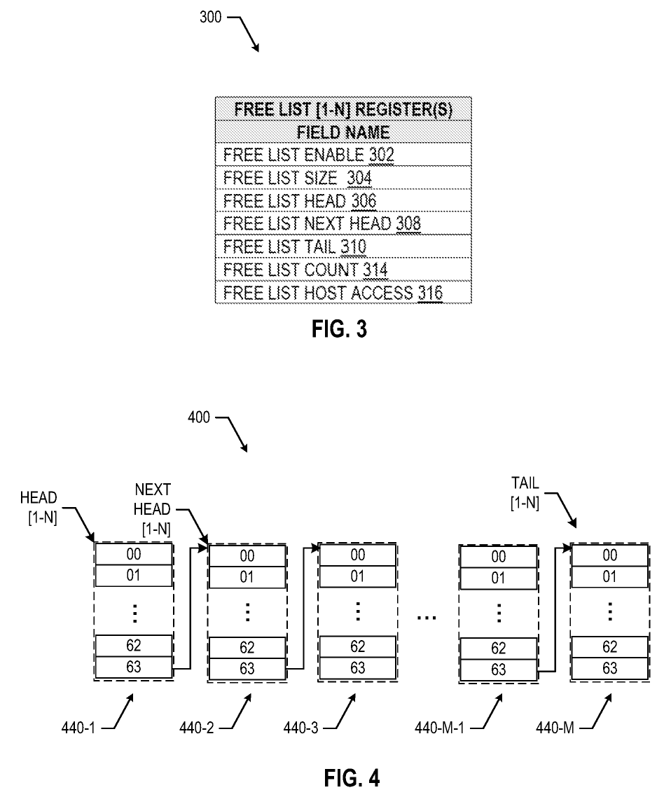

FIG. 3 illustrates an example of a register 300 to enable the implementation of memory free list latency bounding techniques. The register 300 may be an example of the register 118 of FIG. 1. In one example, a memory controller includes a separate register 300 that correspond to each of the memory lists, e.g., each of the memory resources across which data chunks are to be distributed (depicted in FIG. 3 with “[1-N]” to indicate there may be N instances of the register 300, where N represents the number of free lists). For example, if the system 100 of FIG. 1 includes four memory devices (e.g., N=4) and maintains four separate free lists, the memory controller 104 may include four instances of the register 300. In other examples, a single register 300 may include fields that correspond to each of the free lists.

In the example illustrated in FIG. 3, the register 300 includes a “free list enable” field 302. In one such example, a memory controller may write a value (e.g., “1”) to the field 302 to enable a free list or indicate that a free list is enabled. Similarly, the memory controller may write another value (e.g., “0”) to the field 302 to disable a free list or indicate that a free list is disabled. For example, if a memory controller can support four free lists, but is only coupled with two memory devices, two of the free lists may be enabled and two of the free lists may be disabled. In other examples, a free list enable field 302 may be absent from the free list register 300.

The register 300 includes a size field 304. In one example, the size field 304 may indicate the size of the corresponding free list (e.g., the number of addresses that may be stored in the corresponding free list, the number of chunks allocated for storing addresses of free locations in the corresponding free list, or some other information indicating the size of the corresponding free list).

The register 300 includes a head pointer field 306. In one example, the head pointer field 306 includes a pointer to a head of the corresponding free list.

The register 300 includes a next head pointer field 308. In one example, the next head pointer field 308 includes a pointer to the next node (e.g., next chunk) of the corresponding free list. In one such example, the free list may be implemented as a linked list, with each node of the linked list stored as a chunk. In one such example, each chunk of the free list may store a plurality of pointers. In one such example, the head pointer points to the first node or chunk in the free list and the next head pointer points to the second node or chunk in the free list.

The register 300 includes a tail pointer field 310. In one example, the tail pointer field 310 includes a pointer to the last node of the free list.

The register 300 includes a count field 314. In one example, the count field 314 includes a count of free locations (addresses) in a corresponding free list or may otherwise include information that enables a memory control to determine the number of free locations in the corresponding free list.

The register 300 includes a host access field 316. In one example, the host access field may indicate whether a given host has access to a given memory device associated with the free list. For example, in some implementations, one or more memory devices may be made accessible only to one or more requesters and made inaccessible to other requesters. In one such example, the host access field 316 may include a value to reflect which requesters/hosts have access to the memory device corresponding to the free list.

FIG. 3 illustrates one example of register fields that may be used to implement memory free list latency bounding techniques in accordance with examples described herein. In other examples, different, additional, or fewer fields may be present.

Exemplary data structure to store a free list

FIG. 4 illustrates an example data structure to store a free list to enable implementation of memory free list latency bounding techniques, according to some embodiments of the disclosure. The data structure 400 is an example of a linked list with a plurality of nodes 440-1-440-M (of which 440-1, 440-2, 440-3, 440-M-1, and 440-M are shown). In one example, the memory controller may store multiple data structures 400 in memory, where each of the data structures 400 includes addresses of free locations (e.g., chunk pointers) of a corresponding memory device. FIG. 4 depicts a head pointer, a next head pointer, and a tail pointer, which may be examples of the pointers included in the register 300 of FIG. 3.

In the example illustrated in FIG. 4, each nodes 440-1-440-M of the linked list has the size of a data chunk. Consider an example in which the size of a data chunk is 256B and the size of a chunk pointer is 32 bits. Each of the nodes 440-1-440-M may include up to 64 pointers (shown as indices 00, 01, … 62, and 62). In the example illustrated in FIG. 4, each of the nodes 440-1-440-M has space for 62 addresses of free locations in the corresponding memory device (e.g., at indices 00-61 of the node) and space for two next pointers (e.g., in the indices 62 and 63 of the node). In the example shown in FIG. 4, the index 62 includes a next head pointer that points to the head of the next node of the linked list. For example, as can be seen in FIG. 4, the index 63 of the node 440-1 points to the head of the node 440-2.

Exemplary diagram of a free list in memory

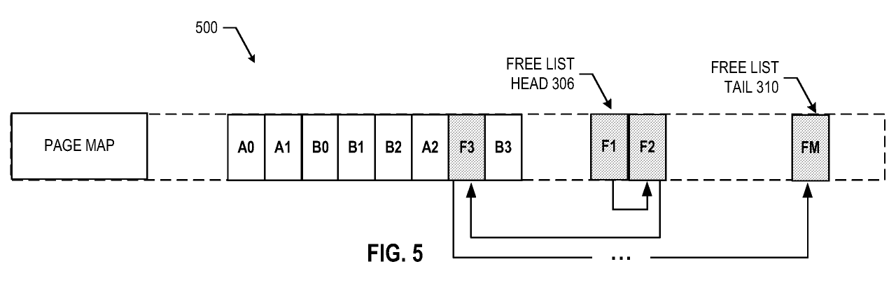

FIG. 5 illustrates an example diagram of memory 500 storing a free list. As mentioned above, a free list may include a plurality of data chunks, where each data chunk includes a plurality of pointers/addresses to free locations in a corresponding memory device. In the example illustrated in FIG. 5, the chunks of the free list are interspersed in memory with data chunks. For example, data chunks are represented by A0, A1, A2 (representing data chunks of a page A) and B0, B1, B2, and B3 (representing data chunks of a different page B). A page map may be stored in memory, which may map a page of data to the data chunks of the page stored in memory 500.

The free list chunks are represented with F1, F2, F3, and FM, where the free list head pointer (e.g., the free list head pointer from the register field 306) is pointing to the first free list chunk F1 and the free list tail pointer (e.g., the free list tail pointer from the register field 310) is pointing to the last free list chunk FM. The chunks F1, F2, F3, and FM are depicting a single free list; chunks for multiple free lists may be interspersed with data chunks in the memory 500 (such as shown in FIG. 2).

Exemplary method for implementing memory free list latency bounding techniques

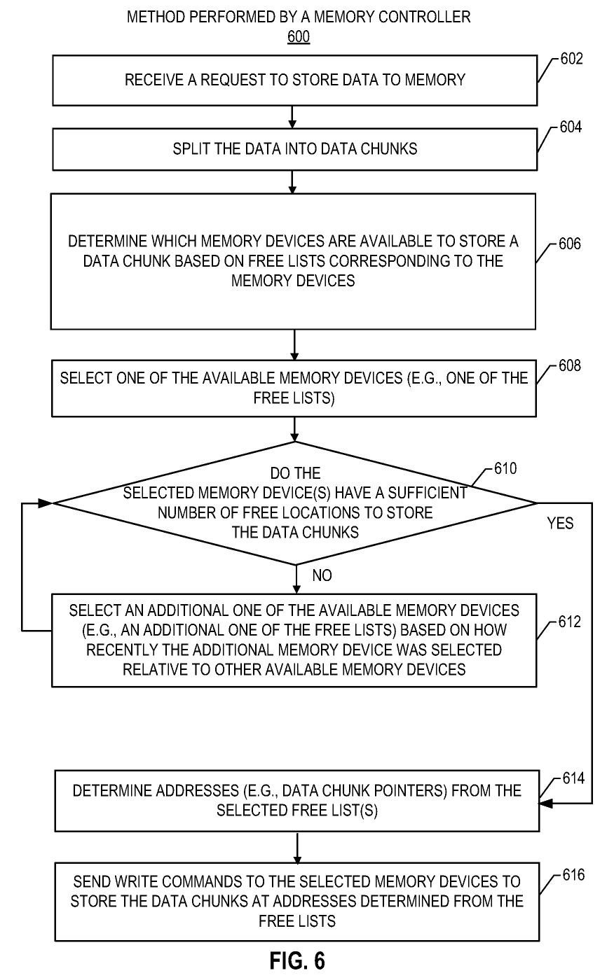

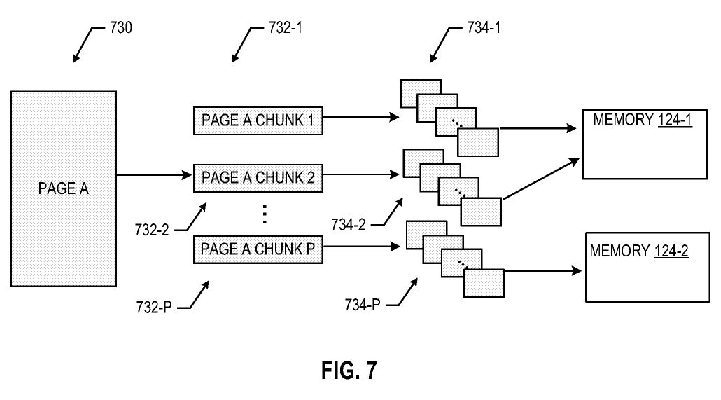

FIG. 6 depicts a flow chart illustrating an example of a method 600 for implementing memory free list latency bounding techniques. The method 600 may be performed by a memory controller (e.g., the free list control logic 116 and/or other logic of the memory controller 104 of FIG. 1). The method 600 may be implemented with hardware, firmware, and/or software. FIG. 7 illustrates a diagram showing an example of data handled in accordance with the method 600, and the following descriptions of method 600 refer to FIG. 7 to help clarify the method 600. The following descriptions of the method 600 also refer to elements of the system 100 of FIG. 1.

The method 600 begins with receiving a request to store data to memory, in 602. For example, referring to FIG. 1, the memory controller 104 may receive a request from the host device 102 (e.g., from a processor 106). In one example, the data received from the requester may be a page of data. A page of data may have a standard size, such as 1KB, 4KB, or another standard size. For example, referring to FIG. 7, the memory controller may receive a page 730 of data (“PAGE A”) from a requester such as the host device 102.

In some examples, a request to store data may occur in response to an eviction from cache (e.g., from the cache 110 of FIG. 1). For example, referring to FIG. 1, when the processor 106 issues a request to store data, the cache controller 128 may check the cache 110 to see if the data is stored in the cache 110, and in response to the data being stored in the cache 110, update the data stored in the cache 110 without writing the data immediately to memory. The data stored in the cache 110 may be decompressed data. A page may be written to memory from the cache when a cache eviction occurs. Cache evictions may occur due to, e.g., cache capacity constraints, cache replacement policies, or explicit cache flush operations, where the evicted page contains modified data that may need to be written back to maintain data consistency. Thus, the cache eviction may result in a store request being sent from the host device 102 to the memory controller 104.

Referring again to FIG. 6, in 604, the memory controller splits the data into data chunks. Splitting the data into data chunks may involve splitting or dividing the data into equal-sized chunks or segments. In the example of FIG. 6, a data chunk has a size that is greater than a memory/DRAM access size (e.g., greater than the size of data accessed in response to a memory read/write command to one of the plurality of memory devices 124-1-124-N). For example, referring to FIG. 7, the page 730 of data is split into P data chunks 732-1-732-P (of which data chunks 732-1, 732-2, and 732-P are shown). In one example, the page 730 may have a size of 4KB, and each of the data chunks 732-1, 732-2, and 732-P may have a size of 256B (one sixteenth the size of the page 730). Thus, in one example, the page 730 may be split into sixteen data chunks 732-1-732-P. In an example in which the size of a DRAM access is 64B, the size of a data chunk 732-1-732-P is four times the size of a DRAM access. Other data chunk sizes are possible (e.g., 128B data chunks, 512B data chunks, etc.). In some examples, prior to splitting the data into data chunks, the data may be compressed and/or encrypted. In some examples in which the page is compressed, fewer data chunks 732-1-732-P (e.g., fewer than 16 data chunks in this example) may be needed to represent the page 730 of data. Thus, a page 730 of data (whether or not the page is compressed and/or encrypted) may be split into, and be made up of, a list of data chunks 732-1, 732-2, and 732-P.

In 606, the memory controller determines which memory devices are available to store a data chunk based on free lists corresponding to the memory devices. For example, referring to FIG. 1, the memory controller 104 may determine which of the memory devices 124-1-124-N are available to store one or more of the data chunks. The memory devices available to store one or more data chunks may be referred to as available memory devices or candidate memory devices. In one example, determining if a memory device is available to store a data chunk involves determining whether a corresponding free list has addresses to free locations in the memory device. For example, the memory controller 104 may check whether the corresponding free list has addresses (e.g., whether the free list is non-empty) or read a register to determine the count of addresses in the corresponding free list (e.g., the register field 314 of FIG. 3). From another perspective, determining which memory devices are available for chunk storage may involve determining which free lists are available (e.g., which free lists are non-empty).

In 608, the memory controller then selects one of the available memory devices to store one or more chunks. Viewed another way, the memory controller may select an available free list. In some examples, selecting an initial memory device for storing one or more data chunks may involve a selection based on a random number. For example, the memory controller may select an initial memory device from the available memory devices (e.g., memory devices determined to be available in 606) based on a random number generated by random number generation logic (e.g., hardware/circuitry such as a linear feedback shift register, firmware, and/or software). The random number may be a pseudo-random number generated based on an algorithm or a true random number generated from unpredictable physical phenomena or processes that exhibit randomness such as electronic noise.

In some examples, the initial memory device for storage of the data chunks may be selected based on the relative capacity of the storage device. For example, selecting the initial memory device may be based on a determination that the first memory device has a greater number of free locations than another memory device that was determined to be available for data chunk storage (e.g., the memory device with the most free locations for data chunk storage may be selected). In some examples, the initial memory device may be selected based on a combination of factors, such as based on a random number and based on the number of free locations in the memory device.

In 610, the memory controller determines whether the selected memory device has a sufficient number of free locations to store the data chunks. For example, referring to FIG. 7, the memory controller has selected the memory device 124-1 and determined that the memory device 124-2 can store two chunks (e.g., based on the free list count register field and/or based on the number of addresses in the corresponding free list). In an example where there are 16 data chunks to store (i.e., P=16), the memory controller would determine that there are insufficient free locations in the memory device 124-1 to store the data chunks (e.g., there are 14 (16 minus 2) more data chunks to store that cannot be stored in the memory device 124-1).

In 612, in response to determining that there are insufficient free locations in the selected memory device, the memory controller selects an additional memory device based on how recently the additional memory device was selected relative to other available memory devices. In some examples, prior to selecting another memory device, the memory controller may re-determine which memory devices are available to store a data chunk.

In one example, selecting an additional memory device may involve selecting the least recently selected memory device from the available memory devices. In one example, selecting an additional memory device based on recency of selection may involve a modulus operation based on the previously selected memory device. Consider an example in which there are four available memory devices for data chunk storage, and four free lists (numbered 0, 1, 2, and 3) corresponding to the four available memory devices (e.g., one free list corresponding to each of the four available memory devices). In one such example, if free list 2 was selected as the initial free list (e.g., selected in 608), then the memory controller may select free list 3 ((2 + 1) mod 4 = 3) in 612. The next iteration (e.g., if an additional memory device is needed to store the data chunks after selecting one additional memory device in 612), the memory device may select free list 0 ((3 + 1) mod = 0). In one such example, the free lists selected for 16 chunks may be 2, 3, 0, 1, 2, 3, 0, 1, 2, 3, 0, 1, 2, 3, 0, 1, resulting in an access pattern distributed across the memory devices corresponding to free lists 0, 1, 2 and 3.

Selecting an additional memory device in 612 may also be based on free capacity. For example, the memory device with the most capacity may be selected from the available memory devices, taking into account which free list(s) were previously selected, until all available free lists have been used once. For example, if the memory controller ranks the memory devices by capacity (e.g., 3, 2, 1, 0, where 3 has the greatest capacity) then the free lists selected for 16 chunks may be 3, 2, 1, 0, 3, 2, 1, 0, 3, 2, 1, 0, 3, 2, 1, 0.

Selecting an additional memory device in 612 may also, or alternatively, be based on other factors. For example, the selection of one or more memory devices may be further based on a determination that the requester/host has permission to access to the memory devices (e.g., based on a register indicating that the host has access to the memory devices/free lists, such as the register field 316 of FIG. 3). In another example, selection of one or more memory devices may be based on performance characteristics of the memory devices. For example, the selection of one or more memory devices may be based further on a value in the one or more registers that weights selection of the one or more memory devices relative to another available memory device. In one such example, the selection may be weighted in favor of selecting a memory device determined to have better performance characteristics, while also taking into consideration which free list(s) were previously selected.

In response to determining, in 610, that the selected memory devices have sufficient free locations to store the data chunks, the memory controller may determine the addresses of the free locations from the selected free lists, in 614. In one example in which each of the selected free lists is implemented as a LIFO stack, obtaining an address for a free location to store a chunk may involve popping from the selected free list, causing the free list to contain one fewer address (as the selected addresses/locations are no longer “free,” but are to contain real allocated data).In an example in which a count register is used to indicate a count of addresses in a free list, the count register may be updated to reflect removal of the addresses from the free list.

In 616, the memory controller then sends write commands to the selected memory devices to store the data chunks at the addresses determined from the free lists. Referring to FIG. 7, in an example in which a data chunk 732-1-732-P is 256B and a memory write is 64B, the memory controller may send four write commands to write four 64B data transfers (shown in FIG. 7 as data transfers 734-1-734-P, of which data transfers 734-1, 734-2, and 734-P are shown) to write each of the data chunks 732-1-732-P). For example, the memory controller sends four write commands to the memory device 124-1 to write the data chunk 732-1 and four write commands to the memory device 124-1 to write the data chunk 732-2. In the example illustrated in FIG. 7, the memory controller sends four write commands to write the data chunk 732-P to the memory device 124-2.

Thus, the page data (e.g., the page 730) may be stored in data chunks in the memory subsystem at the selected chunk pointers determined with the method 600. The method 600 may enable a reduction in the average and tail latencies for reads. In response to a subsequent read request, the page cache (e.g., the cache 110) is checked for the requested data. In the requested data is in the page cache (e.g., if there is a cache hit), the data can be returned to the host from the cache. If the data is not in the cache (e.g., if there is a cache miss), the data is read from memory in chunks (and in some examples, decompressed). The latency for the reads may be reduced based on reading multiple chunks in parallel from multiple storage devices, which may be enabled with the use of multiple free lists, such as described in the method 600. Power savings may also be achieved by distributing data at a higher granularity (e.g., at the data chunk level), where writing each data chunk results in multiple DRAM accesses to the same memory device.

### Exemplary memory module

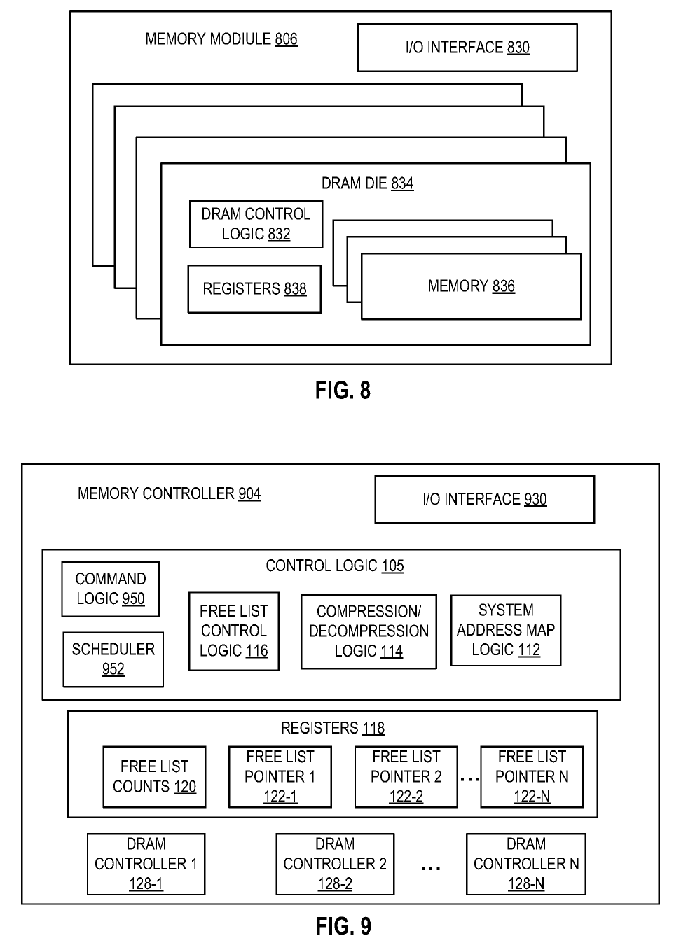

FIG. 8 illustrates an exemplary memory module 806, which may be included in a system implementing memory free list latency bounding techniques. The memory module 806 may be an example a memory device 106-1-106-N of FIG. 1. The memory module 806 may comply with one or more memory standards, such as the standards mentioned above with respect to the memory devices 106-1-106-N.

The memory module 806 includes an I/O interface 830 for interfacing with the memory controller 104, where the I/O interface 830 provides electrical and protocol connections for communication between the memory module 806 and a memory controller (e.g., the memory controller 104 of FIG. 1) through signal pathways including address, data, command, and control signals.

The memory module includes a plurality of DRAM dies or devices 834, where each DRAM device 834 includes memory 836 (e.g., the memory storage media, which may include memory cells arranged in arrays for storing data), DRAM control logic 832 for managing memory operations including read operations, write operations, refresh operations, and timing control functions, and registers 838 for storing configuration parameters, mode settings, and operational status information. The DRAM devices 834 may be electrically connected through the memory module 806 to enable coordinated memory operations, where the I/O interface 830 may distribute commands and addresses from the memory controller 104 to the appropriate DRAM devices 834 and may aggregate data responses from multiple DRAM devices 834 to provide the expected data width.

The memory 836 within each DRAM device 834 may be organized into banks that operate independently for concurrent memory operations, where multiple DRAM devices 834 may be grouped into ranks that respond to commands collectively, and the memory module 806 may support one or more channels for parallel data transfer with the memory controller 104. The memory module 806 may implement pseudo channels that divide a physical channel into multiple independent sub-channels to improve memory access efficiency and reduce latency by enabling more parallel memory operations within the same physical interface.

### Exemplary memory controller

FIG. 6 illustrates an exemplary memory controller in which memory free list latency bounding techniques may be implemented. The memory controller 904 may be an example of the memory controller 104. In one example, the memory controller 904 may be a memory expander, which may also be referred to as a memory expansion controller.

In addition to the components illustrated in FIG. 1, the memory controller 904 illustrated in FIG. 9 includes an I/O interface 930 for communicating with external components such as processors (e.g., the processor 106 of FIG. 1), or other system components through standardized communication protocols and electrical connections, where the I/O interface 930 may handle signal conditioning, protocol translation, and data transfer operations between the memory controller 904 and other devices.

The memory controller 904 includes command logic 950 that processes and interprets commands received from requesters (e.g., from a host device or other requester), where the command logic 950 may decode memory access requests, validate command parameters, and generate appropriate internal control signals and/or commands. The memory controller 904 includes a scheduler 952 that manages the timing and ordering of memory operations (e.g., to optimize performance and ensure compliance with memory device timing requirements), where the scheduler 952 may implement algorithms for command queuing, resource allocation, bank management, and conflict resolution.

The memory controller 904 includes logic (e.g., the free list control logic 116) for implementing memory free list latency bounding techniques in accordance with examples described herein.

### Exemplary host device

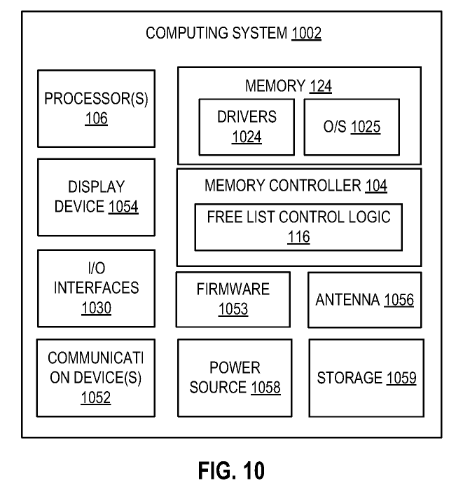

FIG. 10 illustrates an exemplary computing system 1002, which may represent one or more components of a host device in which memory free list latency bounding techniques may be implemented. In some examples, the computing system may be or include a system-on-a-chip (SoC) device. The computing system 1002 may include one or more processors 106, such as CPUs, GPUs, digital signal processors (DSPs), microcontrollers, application-specific integrated circuits (ASICs), field-programmable gate arrays (FPGAs), network processors, audio processors, image processors, cryptographic processors, artificial intelligence accelerators, tensor processing units (TPUs), and/or other processors. The computing system includes memory 124, described above with respect to FIG. 1. The memory 124 may store data and instructions, including instructions for executing an operating system 1025 and drivers 1024. The memory 124 is an example of computer-readable media that may store data and/or instructions. The computing system 1002 includes a memory controller 104 with free list control logic 116 in accordance with examples described herein.

In addition to the memory 124, the system 1002 may include storage 1059, which includes non-volatile storage devices for persistent data retention. For example, the storage 1059 may include solid-state drives (SSDs), hard disk drives (HDDs), flash memory devices, or other non-volatile storage technologies. The storage 1059 may provide long-term data storage capabilities for the computing system 1002 and may interface with other system components through storage protocols such as Serial Advanced Technology Attachment (SATA), Non-Volatile Memory Express (NVMe), or other suitable storage interfaces.

The computing system 1002 includes I/O interfaces 1030 such as Universal Serial Bus (USB), Thunderbolt, Serial Advanced Technology Attachment (SATA), Peripheral Component Interconnect Express (PCIe), Non-Volatile Memory Express (NVMe), Compute Express Link (CXL), Serial Peripheral Interface (SPI), Inter-Integrated Circuit (I2C), Ethernet, wireless communication interfaces including Wi-Fi and Bluetooth, High-Definition Multimedia Interface (HDMI), DisplayPort, and various proprietary or industry-standard communication protocols for connecting peripheral devices, storage systems, and network components.

The computing system 1002 includes firmware 1053, which includes executable code stored in non-volatile memory that configures and controls hardware components during initialization and runtime operations of the system 1002. The computing system 1002 includes one or more power sources 1058, which are components configured to provide electrical energy to support the operation of the computing system. Power sources 1058 may include an alternating current (AC) power supply and a battery. The computing system 1002 may include one or more antenna 1056 configured to enable wireless communication with external devices or networks. The computing system 1002 may include one or more communication devices 1052 comprising wireless and wired communication components such as Wi-Fi transceivers, Bluetooth modules, cellular modems, Ethernet controllers, or radio frequency communication circuits for enabling data exchange with external devices, networks, and communication systems. The communication devices 1052 may facilitate various communication protocols and standards for transmitting and receiving data across different network infrastructures and communication mediums. The computing system 1002 may include a display device 1054 comprising visual output components such as liquid crystal displays (LCD), light-emitting diode (LED) displays, or organic light-emitting diode (OLED) displays, for presenting graphical information, text, images, and user interface elements to a user.

### Select examples

Example 1 provides a method performed by a memory controller coupled with a host and a plurality of memory devices, where the memory controller includes one or more registers to store pointers to a plurality of free lists corresponding to the plurality of memory devices, and where the method includes receiving a request from the host to store data; splitting the data into data chunks, where a size of one of the data chunks is greater than a memory access size (e.g., chunk size is greater than a DRAM access size/the size of data accessed in response to a memory read/write command to one of the plurality of memory devices); selecting one or more memory devices of the plurality of memory devices to store the data chunks, where: selection of the one or more memory devices is based on free lists corresponding to the one or more memory devices, the free lists corresponding to the one or more memory devices include addresses of free locations in the one or more memory devices, and the selection of at least one of the one or more memory devices is further based on how recently the one or more memory devices were selected for data chunk storage relative to another memory device of the plurality of memory devices; and sending write requests to write the data chunks to the one or more memory devices at the addresses of the free locations from the free lists.

Example 2 provides the method of example 1, where: the selection of the one or more memory devices is further based on a determination that the one or more memory devices have a greater number of the free locations (e.g., greater available capacity) relative to one or more other memory devices determined to be available for data chunk storage.

Example 3 provides the method of any one of examples 1-2, where: the selection of the one or more memory devices includes selecting a first memory device (e.g., initial memory device in the selection process) to store one or more of the data chunks, where a first free list corresponding to the first memory device includes first addresses of first free locations, and in response to a determination that the first free locations are insufficient to store the data chunks, selecting a second memory device to store an additional one or more of the data chunks based on how recently the second memory device was selected (e.g., select additional memory devices to store chunks if there are not enough free locations in the first memory device).

Example 4 provides the method of example 3, where selecting the second memory device includes selecting a least recently selected memory device from those of the plurality of memory devices that were determined to be available for the data chunk storage.

Example 5 provides the method of any one of examples 3-4, where: selecting the first memory device is based on a random number (e.g., a pseudo random number or a random number based on noise, etc.).

Example 6 provides the method of example 5, where: selecting the first memory device is further based on a determination that the first memory device has a greater number of free locations than one or more other memory devices determined to be available for the data chunk storage (e.g., selection of the first memory device may be based on both a random number and also weighted based on capacity).

Example 7 provides the method of any one of examples 1-6, where: the selection of the one or more memory devices is further based on a determination that the host has access to the one or more memory devices (e.g., based on a register associated with the free lists corresponding to those memory devices indicating that the host has access to the memory devices/free lists).

Example 8 provides the method of any one of examples 1-7, where: the selection of the one or more memory devices is further based on a value in the one or more registers that weights the selection of the one or more memory devices relative to one or more other devices determined to be available for the data chunk storage (e.g., based on the memory devices having better performance characteristics than other memory devices).

Example 9 provides the method of any one of examples 1-8, where: the memory controller is coupled with a plurality of memory modules that include the plurality of memory devices, and an individual free list of the plurality of free lists corresponds to an individual memory module of the plurality of memory modules (e.g., each list may correspond to a memory module).

Example 10 provides the method of example 9, where: the plurality of memory modules includes a plurality of DIMMs.

Example 11 provides the method of any one of examples 1-8, where: the memory controller is coupled with a memory module, the memory module includes a first pseudo channel including a first plurality of memory devices and a second pseudo channel including a second plurality of memory devices, a first list of the plurality of free lists corresponds to the first pseudo channel, and a second free list of the plurality of free lists corresponds to the second pseudo channel.

Example 12 provides the method of any one of examples 1-11, where: the data has a first size of a page, and splitting the data into the data chunks involves splitting the data into 16 or fewer data chunks (e.g., where each data chunk has a size of four cache lines or 256 bytes, and where the number of data chunks depends on compression).

Example 13 provides the method of any one of examples 1-12, where the one or more registers include one or more fields that indicate a count of the free locations in the free lists corresponding to the plurality of memory devices, and where the method further includes reading the one or more registers to determine which of the plurality of memory devices are available to store one or more of the data chunks based on the count of the free locations.

Example 14 provides the method of any one of examples 1-13, where: prior to sending the write requests, determining the addresses of the free locations from the free lists corresponding to the one or more memory devices selected for storage of the data chunks.

Example 15 provides a memory controller configured to couple with a host and a plurality of memory devices, where the plurality of memory devices includes a first memory device and a second memory device, and where the memory controller includes one or more registers to store pointers to a plurality of free lists, where the plurality of free lists include a first free list with first addresses of first free locations in the first memory device and a second free list with second addresses of second free locations in the second memory device; and logic to: receive a request from the host to store data, split the data into data chunks, where a size of one of the data chunks is greater than a memory access size, determine which of the plurality of memory devices are available to store one or more of the data chunks based on the plurality of free lists; select the first memory device based at least in part on the first free locations in the first free list; determine, based on the first free list, whether the first free locations are sufficient to store the data chunks; in response to a determination that the first free locations are insufficient to store the data chunks, select the second memory device based at least in part on how recently the second memory device was selected for data chunk storage relative to another of the plurality of memory devices; and send first write requests to write one or more of the data chunks to the first memory device at the first addresses and second write requests to write another one or more of the data chunks to the second memory device at the second addresses.

Example 16 provides the memory controller of example 15, where the logic to select the second memory device is to: select the second memory device as a least recently selected memory device.

Example 17 provides the memory controller of any one of examples 15-16, where the logic to select the second memory device is to: select the second memory device further based on a determination that the second memory device has a greater number of free locations (e.g., greater available capacity) than one or more other memory devices determined to be available for data chunk storage.

Example 18 provides the memory controller of any one of examples 15-17, where the logic to select the first memory device is to: select the first memory device further based on a determination that the first memory device has a greater number of free locations than one or more other memory devices determined to be available for data chunk storage.

Example 19 provides the memory controller of any one of examples 15-17, where the logic to select the first memory device is to: select the first memory device further based on a random number (e.g., a pseudo random number or a random number based on noise, etc.).

Example 20 provides the memory controller of example 19, where the logic to select the first memory device is to: select the first memory device further based on a determination that the first memory device has a greater number of free locations than one or more other memory devices determined to be available for data chunk storage (e.g., selection of the first memory device may be based on both a random number and also weighted based on capacity).

Example 21 provides the memory controller of any one of examples 15-20, where the logic to select the first memory device is to: select the first memory device based further on an indication that the host has access to the first memory device (e.g., based on a register associated with the first list).

Example 22 provides the memory controller of any one of examples 15-21, where the logic to select the first memory device is to: select the first memory device based further on a value in a register that weights selection of the first memory device relative to one or more other memory devices determined to be available for data chunk storage (e.g., based on the first device having better performance characteristics than other memory devices).

Example 23 provides the memory controller of any one of examples 15-22, where: the memory controller is coupled with a plurality of memory modules that include the plurality of memory devices, and an individual free list of the plurality of free lists corresponds to an individual memory module of the plurality of memory modules (e.g., each list may correspond to a memory module).

Example 24 provides the memory controller of example 23, where: the plurality of memory modules includes a plurality of DIMMs.

Example 25 provides the memory controller of any one of examples 15-24, where: the memory controller is coupled with a memory module, the memory module includes a first pseudo channel including a first plurality of memory devices and a second pseudo channel including a second plurality of memory devices, the first free list corresponds to the first pseudo channel, and the second free list corresponds to the second pseudo channel.

Example 26 provides the memory controller of any one of examples 15-25, where: the data has a first size of a page, and the logic to split the data into the data chunks is to split the data into 16 or fewer data chunks (e.g., where each data chunk has a size of four cache lines or 256 bytes).

Example 27 provides the memory controller of any one of examples 15-26, where the logic to determine which of the plurality of memory devices are available to store one or more of the data chunks is to: read, for each of the plurality of memory devices, a register that indicates a count of free locations in a corresponding free list.

Example 28 provides the memory controller of any one of examples 15-27, where: prior to sending the first write requests and the second write requests, the logic is to determine first memory addresses for the first free locations from the first free list and determine second memory addresses for the second free locations from the second free list.

Example 29 provides the memory controller of any one of examples 15-28, where: prior to selection of the second memory device, the logic is to re-determine which of the plurality of memory devices are available to store one or more of the data chunks based on the plurality of free lists.

Example 30 provides a system including a processor; and a memory controller coupled with the processor and configured to couple with a plurality of memory devices, where the memory controller includes one or more a registers to store pointers to a plurality of free lists; and logic to: receive a request from the processor to store data, split the data into data chunks, where a size of one of the data chunks is greater than a memory access size, select one or more memory devices of the plurality of memory devices to store the data chunks, where: selection of the one or more memory devices is based on free lists corresponding to the one or more memory devices, the free lists corresponding to the one or more memory devices include addresses of free locations in the one or more memory devices, and the selection of at least one of the one or more memory devices is further based on how recently the one or more memory devices were selected for data chunk storage relative to another memory device of the plurality of memory devices; and send write requests to write the data chunks to the one or more memory devices at the addresses of the free locations from the free lists.

Example 31 provides the system of example 30, where: the selection of the one or more memory devices is further based on a determination that the one or more memory devices have a greater number of the free locations (e.g., greater available capacity) relative to one or more other memory devices determined to be available for the data chunk storage.

Example 32 provides the system of any one of examples 30-31, where: the selection of the one or more memory devices includes selection of a first memory device (e.g., initial memory device in the selection process) to store one or more of the data chunks, where a first free list corresponding to the first memory device includes first addresses of first free locations, and in response to a determination that the first free locations are insufficient to store the data chunks, the logic is to select a second memory device to store an additional one or more of the data chunks based on how recently the second memory device was selected for data chunk storage relative to another memory device of the plurality of memory devices (e.g., select additional memory devices to store chunks if there are not enough free locations in the first memory device).

Example 33 provides the system of example 32, where the logic to select the second memory device is to: select a least recently selected memory device from those of the plurality of memory devices that were determined to be available for data chunk storage.

Example 34 provides the system of any one of examples 32-33, where the logic to select the first memory device is to: select the first memory device based on a random number (e.g., a pseudo random number or a random number based on noise, etc.).

Example 35 provides the system of example 34, where the logic to select the first memory device is to: select the first memory device further based on a determination that the first memory device has a greater number of free locations than another memory device determined to be available for data chunk storage (e.g., selection of the first memory device may be based on both a random number and also weighted based on capacity).

Example 36 provides the system of any one of examples 30-35, where: the selection of the one or more memory devices is further based on a determination that the host has access to the one or more memory devices (e.g., based on a register associated with the free lists corresponding to those memory devices indicating that the host has access to the memory devices/free lists).

Example 37 provides the system of any one of examples 30-36, where: the selection of the one or more memory devices is further based on a value in the one or more registers that weights selection of the one or more memory devices relative to another memory device determined to be available for data chunk storage (e.g., based on the memory devices having better performance characteristics than other memory devices).

Example 38 provides the system of any one of examples 30-37, where: the memory controller is configured to be coupled with a plurality of memory modules that include the plurality of memory devices, and an individual free list of the plurality of free lists corresponds to an individual memory module of the plurality of memory modules (e.g., each list may correspond to a memory module).

Example 39 provides the system of example 38, where: the plurality of memory modules includes a plurality of DIMMs.

Example 40 provides the system of any one of examples 38-39, further including the plurality of memory modules.

Example 41 provides the system of any one of examples 30-37, where: the memory controller is configured to be coupled with a memory module, the memory module includes a first pseudo channel including a first plurality of memory devices and a second pseudo channel including a second plurality of memory devices, a first list of the plurality of free lists corresponds to the first pseudo channel, and a second free list of the plurality of free lists corresponds to the second pseudo channel.

Example 42 provides the system of any one of examples 30-41, where: the data has a first size of a page, and the logic to split the data into the data chunks is to split the data into 16 or fewer data chunks.

Example 43 provides the system of any one of examples 30-42, where the one or more registers include one or more fields that indicate a count of the free locations in the free lists corresponding to the plurality of memory devices, and where the logic is to: read the one or more registers to determine which of the plurality of memory devices are available to store one or more of the data chunks based on the count of the free locations.

Example 44 provides the system of any one of examples 30-43, where: prior to sending the write requests, the logic is to determine the addresses of the free locations from the free lists corresponding to the one or more memory devices selected for storage of the data chunks.

Example 45 provides one or more non-transitory computer-readable media storing instructions (e.g., memory controller firmware) that, when executed by processing logic, cause the one or processing logic to perform a method in a memory controller, where the memory controller is coupled with a host and a plurality of memory devices, where the memory controller includes one or more registers to store pointers to a plurality of free lists corresponding to the plurality of memory devices, and where the method includes receiving a request from the host to store data; splitting the data into data chunks, where a size of one of the data chunks is greater than a memory access size; selecting one or more memory devices of the plurality of memory devices to store the data chunks, where: selection of the one or more memory devices is based on free lists corresponding to the one or more memory devices, the free lists corresponding to the one or more memory devices include addresses of free locations in the one or more memory devices, and the selection of at least one of the one or more memory devices is further based on how recently the one or more memory devices were selected for data chunk storage relative to another memory device of the plurality of memory devices; and sending write requests to write the data chunks to the one or more memory devices at the addresses of the free locations from the free lists.

Example 46 provides the one or more non-transitory computer-readable media of example 45, where the method is in accordance with any one of claims 2-14.

Example 47 provides a memory controller configured to couple with a host and a plurality of memory devices, where the memory controller includes means to store pointers to a plurality of free lists, where plurality of free lists include a first free list with first addresses of first free locations in the first memory device and a second free list with second addresses of second free locations in the second memory device; and means to: receive a request from the host to store data, split the data into data chunks, where a size of one of the data chunks is greater than a memory access size, select one or more memory devices of the plurality of memory devices to store the data chunks, where: selection of the one or more memory devices is based on free lists corresponding to the one or more memory devices, the free lists corresponding to the one or more memory devices include addresses of free locations in the one or more memory devices, and the selection of at least one of the one or more memory devices is further based on how recently the one or more memory devices were selected for data chunk storage relative to another memory device of the plurality of memory devices, and send write requests to write the data chunks to the one or more memory devices at the addresses of the free locations from the free lists.

Example 48 provides the memory controller of example 47, where: the selection of the one or more memory devices is further based on a determination that the one or more memory devices have a greater number of the free locations (e.g., greater available capacity) relative to another memory device that is available for data chunk storage.

Example 49 provides the memory controller of any one of examples 47-48, where: the selection of the one or more memory devices includes selection of a first memory device (e.g., initial memory device in the selection process) to store one or more of the data chunks, where a first free list corresponding to the first memory device includes first addresses of first free locations, and the memory controller includes means to: in response to a determination that the first free locations are insufficient to store the data chunks, select a second memory device to store an additional one or more of the data chunks based on how recently the second memory device was selected for data chunk storage relative to another memory device of the plurality of memory devices (e.g., select additional memory devices to store chunks if there are not enough free locations in the first memory device).

Example 50 provides the memory controller of example 49, where the means to select the second memory device include means to: select a least recently selected memory device from those of the plurality of memory devices that were determined to be available for data chunk storage.

Example 51 provides the memory controller of any one of examples 49-50, where the means to select the first memory device include means to: select the first memory device based on a random number (e.g., a pseudo random number or a random number based on noise, etc.).

Example 52 provides the memory controller of example 51, where the means to select the first memory device include means to: select the first memory device further based on a determination that the first memory device has a greater number of free locations than another memory device determined to be available for data chunk storage (e.g., selection of the first memory device may be based on both a random number and also weighted based on capacity).

Example 53 provides the memory controller of any one of examples 49-52, where: the selection of the one or more memory devices is further based on a determination that the host has access to the one or more memory devices (e.g., based on a register associated with the free lists corresponding to those memory devices indicating that the host has access to the memory devices/free lists).

Example 54 provides the memory controller of any one of examples 49-53, where: the selection of the one or more memory devices is further based on a value in the one or more registers that weights selection of the one or more memory devices relative to another memory device determined to be available for data chunk storage (e.g., based on the memory devices having better performance characteristics than other memory devices).

Example 55 provides the memory controller of any one of examples 49-54, where: the memory controller is configured to be coupled with a plurality of memory modules that include the plurality of memory devices, and an individual free list of the plurality of free lists corresponds to an individual memory module of the plurality of memory modules (e.g., each list may correspond to a memory module).

Example 56 provides the memory controller of example 55, where: the plurality of memory modules includes a plurality of DIMMs.

Example 57 provides the memory controller of any one of examples 49-54, where: the memory controller is configured to be coupled with a memory module, the memory module includes a first pseudo channel including a first plurality of memory devices and a second pseudo channel including a second plurality of memory devices, a first list of the plurality of free lists corresponds to the first pseudo channel, and a second free list of the plurality of free lists corresponds to the second pseudo channel.

Example 58 provides the memory controller of any one of examples 49-57, where: the data has a first size of a page, and the means to split the data into the data chunks is to split the data into 16 or fewer data chunks.

Example 59 provides the memory controller of any one of examples 49-58, further including means to store one or more values to indicate a count of the free locations in the free lists corresponding to the plurality of memory devices; and means to read the one or more values to determine which of the plurality of memory devices are available to store one or more of the data chunks based on the count of the free locations.

Example 60 provides the memory controller of any one of examples 49-59, further including prior to sending the write requests, means to determine the addresses of the free locations from the free lists corresponding to the one or more memory devices selected for storage of the data chunks.

### Variations and other notes

The detailed description, such as the "Select examples" section, provide various examples of the embodiments disclosed herein.

As used herein, the term "coupled to" or "coupled with" refers to a relationship between electronic components or circuit elements wherein the components are in electronic communication with one another and capable of transmitting and/or receiving electrical signals between them. The term "coupled to" does not require a direct physical or electrical connection between the coupled components. Rather, "coupled to" can encompass arrangements where the components are connected through one or more intervening elements, components, circuits, or transmission paths. For example, a first component may be "coupled to" a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase "A and/or B" means (A), (B), or (A and B). For the purposes of the present disclosure, the phrase “A, B, or C” or the phrase "A, B, and/or C" means (A), (B), (C), (A and B), (A and C), (B and C), or (A, B, and C). The term "between," when used with reference to measurement ranges, is inclusive of the ends of the measurement ranges.

The description uses the phrases "in an embodiment" or "in embodiments," which may each refer to one or more of the same or different embodiments. The terms "comprising," "including," "having," and the like, as used with respect to embodiments of the present disclosure, are synonymous. The disclosure may use perspective-based descriptions such as "above," "below," "top," "bottom," and "side" to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/- 20% of a target value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method performed by a memory controller coupled with a host and a plurality of memory devices, wherein the memory controller comprises one or more registers to store pointers to a plurality of free lists corresponding to the plurality of memory devices, and wherein the method comprises:
receiving a request from the host to store data;
splitting the data into data chunks, wherein a size of one of the data chunks is greater than a memory access size;
selecting one or more memory devices of the plurality of memory devices to store the data chunks, wherein:
selection of the one or more memory devices is based on free lists corresponding to the one or more memory devices,
the free lists corresponding to the one or more memory devices comprise addresses of free locations in the one or more memory devices, and
the selection of at least one of the one or more memory devices is further based on how recently the one or more memory devices were selected for data chunk storage relative to another memory device of the plurality of memory devices; and
sending write requests to write the data chunks to the one or more memory devices at the addresses of the free locations from the free lists.

2. The method of claim 1, wherein:
the selection of the one or more memory devices is further based on a determination that the one or more memory devices have a greater number of the free locations relative to one or more other memory devices that are available for data chunk storage.

3. The method of claim 1, wherein:
the selection of the one or more memory devices comprises:
selecting a first memory device to store one or more of the data chunks, wherein a first free list corresponding to the first memory device comprises first addresses of first free locations, and
in response to a determination that the first free locations are insufficient to store the data chunks, selecting a second memory device to store an additional one or more of the data chunks based on how recently the second memory device was selected.

4. The method of claim 3, wherein selecting the second memory device comprises:
selecting a least recently selected memory device.

5. The method of claim 3, wherein:
selecting the first memory device is based on a random number.

6. The method of claim 5, wherein:
selecting the first memory device is further based on a determination that the first memory device has a greater number of free locations than one or more other memory devices determined to be available for the data chunk storage.

7. The method of claim 1, wherein:
the selection of the one or more memory devices is further based on a determination that the host has access to the one or more memory devices.

8. The method of claim 1, wherein:
the selection of the one or more memory devices is further based on a value in the one or more registers that weights the selection of the one or more memory devices relative to one or more other memory devices determined to be available for the data chunk storage.

9. The method of claim 1, wherein:
the memory controller is coupled with a plurality of memory modules that comprise the plurality of memory devices, and
an individual free list of the plurality of free lists corresponds to an individual memory module of the plurality of memory modules.

10. The method of claim 9, wherein:
the plurality of memory modules comprises a plurality of dual inline memory modules (DIMMs).

11. The method of claim 1, wherein:
the memory controller is coupled with a memory module,
the memory module comprises a first pseudo channel comprising a first plurality of memory devices and a second pseudo channel comprising a second plurality of memory devices,
a first list of the plurality of free lists corresponds to the first pseudo channel, and
a second free list of the plurality of free lists corresponds to the second pseudo channel.

12. The method of claim 1, wherein:
the data has a first size of a page, and
a data chunk has a second size of multiple cache lines.

13. The method of claim 1, wherein the one or more registers comprise one or more fields that indicate a count of the free locations in the free lists corresponding to the plurality of memory devices, and wherein the method further comprises:
reading the one or more registers to determine which of the plurality of memory devices are available to store one or more of the data chunks based on the count of the free locations.

14. The method of claim 1, wherein:
prior to sending the write requests, determining the addresses of the free locations from the free lists corresponding to the one or more memory devices selected for storage of the data chunks.

15. A memory controller configured to couple with a host and a plurality of memory devices, wherein the plurality of memory devices comprises a first memory device and a second memory device, and wherein the memory controller comprises:
one or more registers to store pointers to a plurality of free lists, wherein the plurality of free lists comprise a first free list with first addresses of first free locations in the first memory device and a second free list with second addresses of second free locations in the second memory device; and
logic to:
receive a request from the host to store data,
split the data into data chunks, wherein a size of one of the data chunks is greater than a memory access size,
determine which of the plurality of memory devices are available to store one or more of the data chunks based on the plurality of free lists;
select the first memory device based at least in part on the first free locations in the first free list;
determine, based on the first free list, whether the first free locations are sufficient to store the data chunks;
in response to a determination that the first free locations are insufficient to store the data chunks, select the second memory device based at least in part on how recently the second memory device was selected for data chunk storage relative to another of the plurality of memory devices; and
send first write requests to write one or more of the data chunks to the first memory device at the first addresses and second write requests to write another one or more of the data chunks to the second memory device at the second addresses.

16. The memory controller of claim 15, wherein the logic to select the second memory device is to:
select the second memory device as a least recently selected memory device.

17. The memory controller of claim 15, wherein the logic to select the second memory device is to:
select the second memory device further based on a determination that the second memory device has a greater number of free locations than one or more other memory devices determined to be available for the data chunk storage.

18. The memory controller of claim 15, wherein the logic to select the first memory device is to:
select the first memory device further based on a determination that the first memory device has a greater number of free locations than one or more other memory devices determined to be available for the data chunk storage.

19. A system implementing memory management techniques for parallel memory access to a plurality of memory devices, the system comprising:
a processor; and
a memory controller coupled with the processor and configured to couple with the plurality of memory devices, wherein the memory controller comprises:
one or more registers to store pointers to a plurality of free lists; and
logic to:
receive a request from the processor to store data,
split the data into data chunks, wherein a size of one of the data chunks is greater than a memory access size,
select one or more memory devices of the plurality of memory devices to store the data chunks, wherein:
selection of the one or more memory devices is based on free lists corresponding to the one or more memory devices,
the free lists corresponding to the one or more memory devices comprise addresses of free locations in the one or more memory devices, and
the selection of at least one of the one or more memory devices is further based on how recently the one or more memory devices were selected for data chunk storage relative to another memory device of the plurality of memory devices; and
send write requests to write the data chunks to the one or more memory devices at the addresses of the free locations from the free lists.

20. The system of claim 19, wherein:
the selection of the one or more memory devices is further based on a determination that the one or more memory devices have a greater number of the free locations relative to one or more other memory devices determined to be available for the data chunk storage.
